(19) United States
(12) Patent Application Publication
(10) Pub. No.: US 2007/0059450 A1
(43) Pub. Date: Mar. 15, 2007

(54) Ed's baby powder glaze polish

(76) Inventor: Edward Marlin Bryant, Detroit, MI (US)

Correspondence Address: Edward Marlin Bryant, 19145 Fielding, Detroit, MI, 48219, US

(21) Appl. No.: 11/518,967

(22) Filed: Sep. 11, 2006

Related U.S. Application Data
(60) Provisional application No. 60/716,651, filed on Sep. 14, 2005.

(51) Int. Cl. B05D 3/12

(52) U.S. Cl. 427/355

(57) ABSTRACT

This invention relates to the creation of a paste for polishing an auto vehicles body cleaning windows and mirrors derived from mixing body powder and water together changes the dry body powder into a wet pliable paste, suitable for applying onto vehicles bodies, windows, mirrors, chrome wheels, aluminum, plastic or metal hubcaps and jewelry, precious metals gold and silver. After applying this mixture onto your vehicles surface and etc., also on your precious metals, the mixture dries and leaves a white hazy film. For removing this film use a very wet towel for rinsing purposes then wringing the towel out [squeezing out the excess water] you use the towel to wipe the vehicle off leaving a very shiny surface. Polishing your vehicle with a dry clean towel lastly, will give that glaze like [smooth and glossy] results.

Lay a water soaked towel, flat on the hood or trunk of your vehicle. Pour six table spoons of baby powder or six squirts from baby powder container on the water soaked towel. Massage or knead the water soaked towel, with the baby powder on it, until the baby powder becomes a paste on the towel.

how to use it

first: Make sure that your vehicle(car, truck, van, suv, motorcycle etc.) Have been washed clean first. then using the water soaked towel with the paste on it, apply it over the entire car. except the rubber tires. You can apply the glaze polish on the wheels chrome, aluminum, plastic, use it on the mirror's, windows, headlamps, tail lights etc.

second: let the car dry all over to a white coat of powder.

Third: you need 2 clean towels, a bucket of water or water hose. soak 1 towel wet, rinse the car off all over with it. Wring the same towel out and remove the excess powder from the surface of the vehicle. by using the damp towel to wipe off the excess powder from the car, you will notice a very shiny surface is left behind.

Forth: take the dry towel and the damp towel, fold both towels, and proceed to polish in 1 step by step by placing the damp towel in front of the dry towel wiping the car down. for that high gloss, simply use the dry towel and buff the surface by using the damp towel to remove excess powder. for the ultimate shine, you spit shine the surface of the car by using cotton balls dipped in water. buff the car using circular motions until you get the desired effect.

the benefits of this invention

the consumer will find that by using this process, the cars surface will be better protected by my glaze than most other glazes on the market. They will find that their vehicles will be easier to clean. There will be more beading after it rains. A regular car wash is all it needs for a period of 4 months due to the resilience of the product. After using ed's baby powder glaze polish, almost nothing sticks to the surface of your vehicle. Bird droppings and bugs willstick, but a little water with a towel will wipe it right off. again, this process is super for all chrome on your car. Use it in your bathroom and kitchen sinks and on the faucets, mirrors etc,.

I, Edward M. Bryant, feel thta the baby powder industry will grow when i introduce this un2obvious use of their product.

I claim:

1. A method for polishing auto vehicles bodies, chrome and aluminium wheels, plastic or Metal hubcaps and jewelry, delivering a smooth and glossy shined, water resistance [beading] durable finish when mixing body powder and water together creating a pliable paste suitable for application and removal using a water soaked towel or a water hose.

2. A method of claim 1 for cleaning windows and mirrors using the application procedure from claim 1.

3. A method of claim 1 for preserving gloss longevity, for four or more months without reapplication Just wash and dry.

4. A method of claim 1 that allows a hard rain to nearly wash the top half of a sightly dirty vehicle, While it sits in the drive way.
